(19) United States
(12) Patent Application Publication
(10) Pub. No.: US 2021/0201661 A1
(43) Pub. Date: Jul. 1, 2021

(54) System and Method of Hand Gesture Detection

(71) Applicant: Midea Group Co., Ltd., Foshan (CN)

(72) Inventors: Mohamad AL JAZAERY, San Jose, CA (US); Zhicai OU, San Jose, CA (US)

(21) Appl. No.: 16/732,147

(22) Filed: Dec. 31, 2019

(51) Int. Cl. G08C 23/00; G06F 3/01; G06K 9/00; G06K 9/42; G06N 3/04; G06N 3/08; G05B 13/02

(52) U.S. Cl. CPC G08C 23/00; G06F 3/017; G06K 9/00335; G06K 9/00362; G08C 2201/32; G06N 3/0454; G06N 3/08; G05B 13/027; G06K 9/42

(57) ABSTRACT

A method includes: identifying, using a first image processing process, one or more first regions of interest (ROI), the first image processing process configured to identify first ROIs corresponding to a predefined portion of a respective human user in an input image; providing a downsized copy of a respective first ROI identified in the input image as input for a second image processing process, the second image processing process configured to identify a predefined feature of a respective human user and to determine a respective control gesture of a plurality of predefined control gestures corresponding to the identified predefined feature; and in accordance with a determination that a first control gesture is identified in the respective first ROI identified in the input image, and that the first control gesture meets preset criteria, performing a control operation in accordance with the first control gesture.

### TECHNICAL FIELD

The present disclosure relates to the field of machine control, and in particular, to a method and system for controlling appliances using near-range hand gestures.

### BACKGROUND

Home appliances provide various dedicated functions to home users. Each appliance has its own control user interface that is operable via various input modalities, and each appliance provides feedback to the user via various output modalities. User interface design for home appliances is critical in affecting the usage efficiency and user experience when interacting with the home appliances.

Conventional home appliances are controlled by knobs and touch panels. However, a touch-based input interface requires the user to be physically present at the home appliance that he/she wants to control, and requires a certain amount of strength and dexterity on the part of the user to accurately control the appliances. A mobility-challenged user (e.g., a bedridden patient, a wheelchair-bound user, elderly user, etc.) may not be able to get to the control panel of an appliance easily (e.g., in a kitchen or other small spaces). Sometimes, a sitting user (e.g., a user sitting on a wheelchair), or a user with short stature (e.g., a child) may have trouble reaching the control panel of an appliance. Even though a remote controller may help in some instances, if the remote controller is not near the user or cannot be found at the time of need, the user will not be able to control the appliances as needed.

Recently, voice-based digital assistants have been introduced into the marketplace to handle various tasks such as home appliance controls, web search, calendaring, reminders, etc. One advantage of such voice-based digital assistants is that users can interact with a device in a hands-free manner without handling or even looking at the device. However, sometimes, a voice-based input interface is not useful, e.g., for speech-impaired users, or in a noisy environment. In addition, the speech user interface requires sophisticated natural language processing capabilities, which is difficult to perfect in light of varied accents and speaking habits of users.

Thus, it would be beneficial to provide an alternative system to implement gesture-based controls on an embedded system with better accuracy, quicker responsiveness, and longer range.

### SUMMARY

Although some smart appliances may implement hand gesture-based controls, these features are often implemented using IR-based technology—therefore requiring a user to be within a very short distance of the appliance. In addition, for hand gesture detection based on RGB image analysis, a user is often required to be within 5-6 meters of the camera as the user's hands become very small outside of this range and the image could no longer obtain enough visual discriminative features of the user's hands. Although using higher-resolution images could improve detection accuracy and range, processing a high-resolution image is very computationally costly. Moving the image analysis to a cloud server is both expensive and may incur privacy risks.

Accordingly, there is a need for a method to control home appliances with limited computation power using gestures within 5-6 meters of the home appliances, but not within arm's reach of the home appliances. The home appliances can respond quickly to the user's gestures without undue delays. The user is able to make the gestures without being very close to the appliance. For example, a user can be in the middle of a room, sitting on a couch, or in bed, and perform the gestures to control an appliance that is located away from the user in the same room. This is particularly beneficial to users with limited mobility, and allows them to control multiple appliances from the same location in the room. This is also helpful for controlling appliances that are sensitive or dangerous. For example, a user can control the stove with a gesture without touching any part of the stove, thus avoiding touching any hot surface on the stove or being splattered with hot oil. This is also helpful in situations where the appliance is sensitive to disturbances caused by contact (e.g., a smart fish tank for sensitive or dangerous pets), and a user can control the appliance (e.g., setting internal environment, and release food or water to the pet, etc.) without direct contact with the appliance. This is also helpful in situations where the user does not want to touch the appliance's control panel because the user's hands are contaminated (e.g., the user's hands are wet), and the user can control the appliance using gestures.

In some embodiments, a method of controlling home appliances via gestures, includes: identifying, using a first image processing process, one or more first regions of interest (ROI) in a first input image, wherein the first image processing process is configured to identify first ROIs corresponding to a predefined portion of a respective human user in an input image; providing a downsized copy of a respective first ROI identified in the first input image as input for a second image processing process, wherein the second image processing process is configured to identify one or more predefined features of a respective human user and to determine a respective control gesture of a plurality of predefined control gestures corresponding to the identified one or more predefined features; and in accordance with a determination that a first control gesture is identified in the respective first ROI identified in the first input image, and that the first control gesture meets preset first criteria associated with a respective machine, triggering a control operation at the respective machine in accordance with the first control gesture.

In accordance with some embodiments, a computer-readable storage medium (e.g., a non-transitory computer-readable storage medium) is provided, the computer-readable storage medium storing one or more programs for execution by one or more processors of an electronic device, the one or more programs including instructions for performing any of the methods described herein.

In accordance with some embodiments, an electronic device (e.g., a portable electronic device) is provided that comprises means for performing any of the methods described herein.

In accordance with some embodiments, an electronic device (e.g., a portable electronic device) is provided that comprises one or more processors and memory storing one or more programs for execution by the one or more processors, the one or more programs including instructions for performing any of the methods described herein.

In accordance with some embodiments, an information processing apparatus for use in an electronic device is provided, the information processing apparatus comprising means for performing any of the methods described herein.

### BRIEF DESCRIPTION OF THE DRAWINGS

The aforementioned features and advantages of the disclosed technology as well as additional features and advantages thereof will be more clearly understood hereinafter as a result of a detailed description of preferred embodiments when taken in conjunction with the drawings.

To describe the technical solutions in the embodiments of the presently disclosed technology or in the prior art more clearly, the following briefly introduces the accompanying drawings required for describing the embodiments or the prior art. Apparently, the accompanying drawings in the following description show merely some embodiments of the presently disclosed technology, and persons of ordinary skill in the art may still derive other drawings from these accompanying drawings without creative efforts.

FIG. 1 is a block diagram illustrating an operating environment of one or more home appliances in accordance with some embodiments.

FIG. 2 is a block diagram of an exemplary home appliance in accordance with some embodiments.

FIG. 3 illustrates a processing pipeline for determining control gestures from image analysis of an image in accordance with some embodiments.

FIG. 4 illustrates an image processing process for determining one or more regions of interest from image analysis of an image in accordance with some embodiments.

FIG. 5 illustrates an image processing process for determining a control gesture from image analysis of an image in accordance with some embodiments

FIG. 6 is a flowchart diagram of a method of controlling a machine via user gestures in accordance with some embodiments.

FIG. 7 is a block diagram of a computing system in accordance with some embodiments.

Like reference numerals refer to corresponding parts throughout the several views of the drawings.

### DESCRIPTION OF EMBODIMENTS

The method and configuration of functions set forth herein address the issues and shortcomings of the conventional methods outline above, and offer at least some of the advantages set forth below. Other advantages will be apparent in light of the disclosure provided herein.

As discussed in the background section, conventional touch-based control for home appliances is not user-friendly in many cases because a user is required to be very close to the appliance (e.g., with the user's hands being in contact with the appliance's control panel in most of the cases). This makes it dangerous for the user when the appliance is a hot stove. Also, sometimes, when the user's hands are wet or contaminated with some substances (e.g., raw chick, dirt, slime, oil, etc.), using a touch-based control panel on the appliance or a remote controller (e.g. clicking control buttons on the touch-panel or remote controller) could be unsanitary and cause additional cleaning of the appliance later.

Additionally, a touch-based remote controller can be lost or out of reach in the moment of needs. Therefore, it is advantageous to implement a way to control appliances without requiring a touch-based input on a remote controller.

Conventionally, a voice-based user interface can serve as a touchless alternative to a touch-based control user interface. However, a voice-based user interface does not work well in a noisy environment, e.g. when a party is going on in the house. In addition, the voice-based user interface cannot quickly adapt to a new user (e.g., a visitor to the house) that has a different accent, or does not speak the language accepted by the voice-based user interface. Furthermore, for speech-impaired users (e.g., a stroke patient who has slurred speech, or a toddler who does not speak clearly, or a mute person), the voice-based user interface will not work at all.

As disclosed herein, the mid-range gesture interface is an alternate of the voice-based user interface and the touch-based user interface. The gesture user interface provides the following advantages. First, gestures are universal, to users of all languages and accents. Gestures work well in noisy environments. Gestures also work well for people who do not speak (e.g., deaf people or mute people who can use sign languages).

As disclosed herein, using the camera makes it possible to control appliances with not only hands but also body language. It also makes it possible to control appliances, with not only hands, but also relative movement of head and hands.

Detecting gestures from a reasonable distance away, the mid-range cameras allow the user to stand sufficiently far to control an appliance, which makes it safer and eliminates the need for the user to get close to the appliance.

In some embodiments, when training the image analysis models, gesture image data of the predefined classes of gestures are collected, and a three-dimensional convolutional deep model is trained using the labeled gesture images. Once trained, the convolutional deep module can be used to recognize gestures using input images of users. As disclosed herein, the efficiency of gesture recognition affects the speed by which the gesture is recognized, and the computation power needed to process the images. Using the method and system disclosed herein, the input image for the gesture recognition is very small, resulting in faster recognition without requiring much computational power or a connection to a remote server. This reduces the cost of adding gesture control to an appliance and protects the user's privacy in his home.

As also disclosed herein, utilizing a built-in camera to capture images of a user to control a corresponding appliance is useful. However, sometimes, the user has multiple appliances and multiple appliances may capture the images of the user making the gesture at the same time. Sometimes, not all appliances have the built-in cameras to capture the gesture, even though the user would like to control all appliances with gestures. In this disclosure, the image capturing functions of appliances are optionally shared among multiple appliances (e.g., appliances with cameras and appliances without cameras), and the target appliance for the gesture is not necessarily the appliance that captured the video of the gesture. Carefully designed way to determine a suitable target appliance for a detected gesture is also discussed, such that the gestures are made applicable to more appliances, without requiring all appliances to have a camera and video processing capabilities, and without requiring the user to face a particular appliance or move to a particular location in order to control a desired appliance.

Other advantages and benefits of the method and system described herein are apparent to a person skilled in the art in light of the disclosure provided herein.

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The following clearly and completely describes the technical solutions in the embodiments of the present application with reference to the accompanying drawings in the embodiments of the present application. Apparently, the described embodiments are merely a part rather than all of the embodiments of the present application. All other embodiments obtained by persons of ordinary skill in the art based on the embodiments of the present application without creative efforts shall fall within the protection scope of the present application.

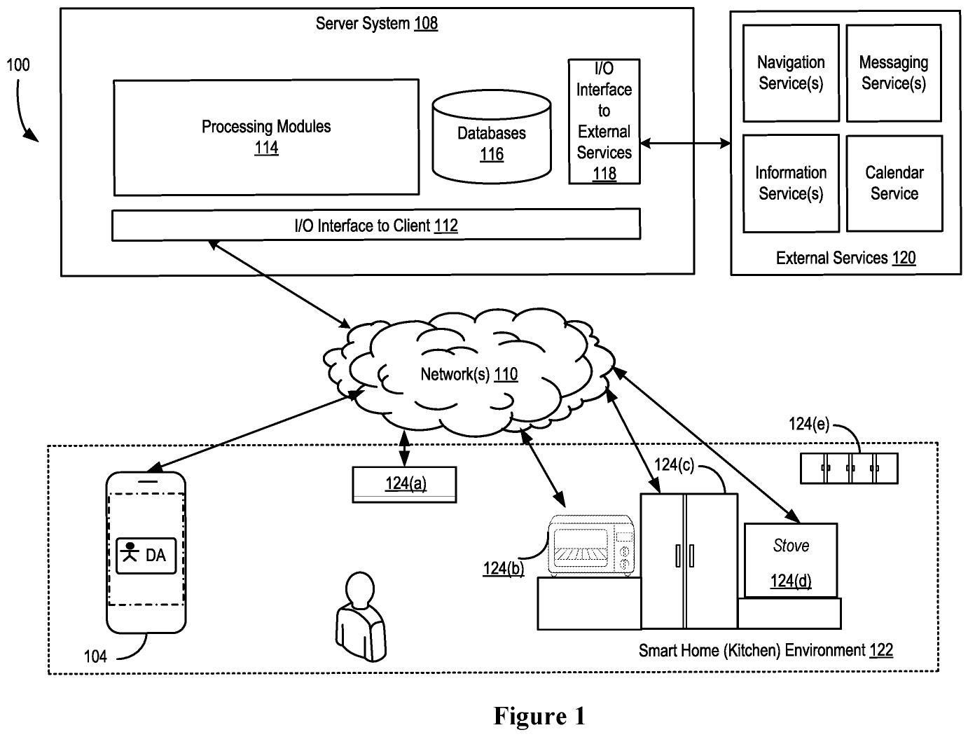

FIG. 1 is a block diagram illustrating an operating environment 100 of one or more home appliances in accordance with some embodiments.

The operating environment 100 is optionally implemented according to a client-server model. The operating environment 100 includes a smart home environment 122 (e.g., a smart kitchen of the smart home environment is shown in FIG. 1) and a server system 108 communicatively coupled with the smart home environment 122 via cloud networks 110. In some embodiments, the smart home environment 122 includes one or more smart home appliances 124. Examples of the smart home appliances 124 include refrigerators 124(c), microwave ovens 124(b), smart stoves 124(d), smart storage cabinets 124(e), smart air conditioner 124(a), smart entertainment center, etc. In some embodiments, the client-side environment 100 further includes a user device 104 (e.g., a smartphone, a tablet, a personal computer, or a central communication hub).

As an example, the smart home environment includes a first home appliance, e.g., a smart air conditioner 124(a) that is located on a wall of the kitchen near the ceiling. The smart home environment further includes a second home appliance, e.g., a refrigerator 124(c), that is located between two other smart home appliances, e.g., smart oven 124(d) and smart microwave oven 124(b), all of the three appliances are placed against a wall of the kitchen opposite the air conditioner 124(a).

In some embodiments, a respective appliance of the one or more appliances 124 includes an input/output user interface. The input/output user interface optionally includes one or more output devices that enable the presentation of media content, including one or more speakers and/or one or more visual displays. The input/output user interface also optionally includes one or more input devices, including user interface components that facilitate user input, such as a keypad, a voice-command input unit or microphone, a touch screen display, a touch-sensitive input pad, a gesture capturing camera, or other input buttons or controls.

In some embodiments, a respective appliance of the one or more appliances 124 further includes sensors, which senses environment information of the respective appliance. Sensors include but are not limited to one or more light sensors, cameras (also referred to as image sensors), humidity sensors, temperature sensors, motion sensors, weight sensors, spectrometers, and other sensors. In some embodiments, the sensors associated with various appliances are used to provide user presence information (e.g., location of the user in the room, and which appliance(s) that the user is currently interacting with, etc.). In some embodiments, the sensors also provide information on the indoor environment, such as temperature, time of day, lighting, noise level, activity level of the room. This environment information can further be used to select suitable user interface configuration for an appliance, in addition to the recognized gestures of the user that is performed in front of the appliance.

In some embodiments, one or more devices and/or appliances in the kitchen area includes a respective camera and a respective motion sensor to detect presence of a user and captures images of the user. The user can move about the smart kitchen environment, and multiple devices 124 that are located in the vicinity of the user can capture the user's images, and optionally, independently transmit the images to the server system 108 through their own communication channels to the server. In some embodiments the server, optionally, transmits a trained image processing models to one or more of the devices and/or appliances to allow one or more of the devices and/or appliances in the smart home environment to process the images captured in the smart home environment 122 without requiring the images to be transmitted to the server.

In some embodiments, the server system 108 includes one or more processing modules 114, data and models 116, an I/O interface to client 112, and an I/O interface to external services 118. The client-facing I/O interface 112 facilitates the client-facing input and output processing for the server system 108. For example, the server optionally provides the image processing services for a particular appliance based on the images submitted by the appliance. The database and models 116 include various user data for each user and/or household of users, such as individual user's account data (e.g., images, age, gender, characteristics, etc.), and user interface configuration preferences and restrictions, etc. The one or more processing modules 114 utilize the data and models 116 to monitor presence of users and gestures performed by the users to determine a suitable control command and a suitable target appliance for the control command.

In some embodiments, the server system 108 also communicates with external services 120 (e.g., navigation service(s), messaging service(s), information service(s), calendar services, home appliance control service(s), social networking service(s), etc.) through the network(s) 110 for task completion or information acquisition. The I/O interface to the external services 118 facilitates such communications.

In some embodiments, the server system 108 can be implemented on at least one data processing apparatus and/or a distributed network of computers. In some embodiments, the server system 108 also employs various virtual devices and/or services of third party service providers (e.g., third-party cloud service providers) to provide the underlying computing resources and/or infrastructure resources of the server system 108.

Examples of the communication network(s) 110 include local area networks (LAN) and wide area networks (WAN), e.g., the Internet. The communication network(s) 110 may be implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some embodiments, the image processing functions and user interface configuration adjustment functions disclosed herein are provided remotely by the server 108, or locally by the smart appliances, and/or jointly through a cooperation between the server and the appliances, as described herein.

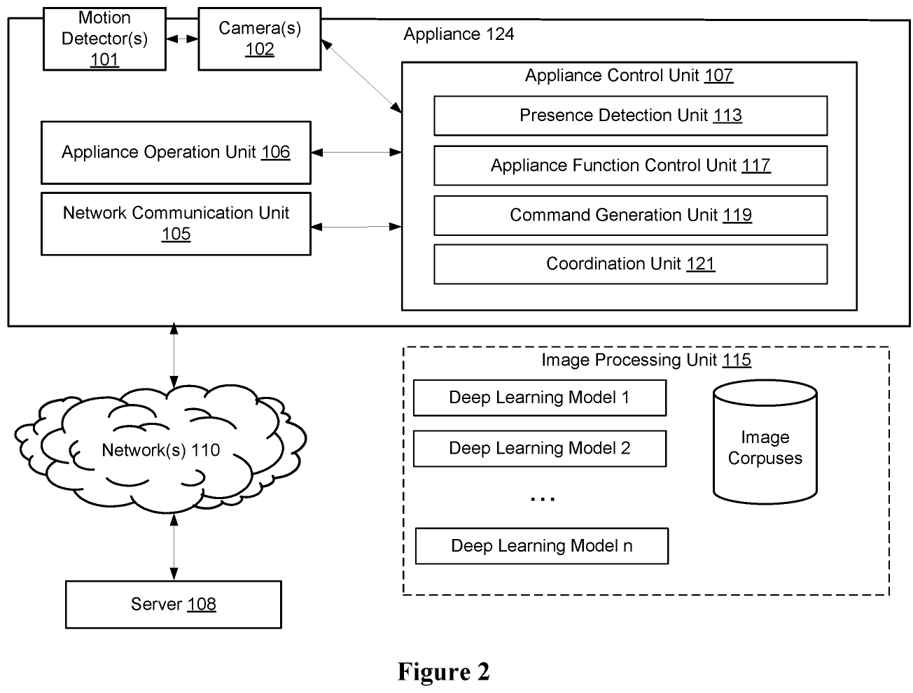

As shown in FIG. 2, an exemplary smart appliance 124 (e.g., smart air conditioner 124(a), smart refrigerator 124(c), smart oven 124(d), or smart microwave oven 124(b)) includes one or more presence sensors, such as one or more motion detectors 101 and one or more onboard cameras 102, an appliance control unit 107, and an appliance operation unit 106. In some embodiments, the appliance 124 further includes a network communication unit 105 that communicates with a remote server 108 via one or more networks 110 (e.g., a local area network (LAN), a wide area network (WAN), and/or the Internet). In some embodiments, the appliance control unit 107 further includes presence detection unit 113 for controlling the one or more motion detectors 101 and the one or more cameras 102 to detect presence of a user in the vicinity of the appliance 124 and capturing images of the user upon detection presence of the user satisfying preset criteria. In some embodiments, the appliance control unit 107 further includes an appliance function control unit 117 for controlling the appliance operation unit 106. In some embodiments, the appliance control unit 107 further includes a command generation unit 119 for generating a corresponding control command for a target appliance based on the gesture(s) deduced from image analysis of the user's images. In some embodiments, the appliance control unit 107 further includes a coordination unit 121 that coordinates the presence detection, image capturing, control command generation and delivery functions of appliances that are associated with one another, or physically near one another, such that the result of the detection, image capturing, analysis, and conclusions of the multiple appliances may be shared and coordinated to reduce power usage, improve analysis accuracy, reducing response time, and improving overall user experience when interacting with multiple appliances in the same room around the same time.

In some embodiments, the appliance control unit 107 further includes an image processing unit 115 which includes one or more machine learning models for analyzing a sequence of images (e.g., consecutive image frames of a video) from the one or more cameras 102, and provide gestures deduced from the image analysis performed on the images. In some embodiments, the image processing unit 115 optionally include some components locally at the appliance 124, and some components remotely at the server 108. In some embodiments, the image processing unit 115 is entirely located on the server 108. In some embodiments, the image processing unit 115 is located on an electronic device (e.g., a user device (e.g., a smart watch, a smart phone, a home computer, etc.) that is also located in the smart home environment) that is not located remotely from the smart home environment.

In some embodiments, the appliance 124 includes a mechanism for moving and focusing the cameras onto a user's face after the user's presence is detected. For example, the appliance includes a mounting bracket for the cameras that is controlled by one or more motors and actuators, and can change an orientation of the camera(s) (e.g., the tilt and yaw of the camera) relative to the detected user.

In some embodiments, a single camera is placed on the front side of the appliance (e.g., near the center of the upper or lower edge of the front side of the appliance's enclosure). In some embodiments, the camera is mounted on a platform with one or more actuators that are controlled (e.g., controlled via a remote control operated by a user, or controlled automatically by the appliance control unit 104) to change an orientation and/or location of the camera (e.g., by changing the tilt and yaw of the plane of the front-side of the camera, or anchor position of the camera) relative to a reference point (e.g., a fixed point on the front side of the appliance), to provide stereo imaging capability to the appliance 124. In some embodiments, two cameras are placed at two opposing corners of the appliance (e.g., in proximity to the two upper corners of the front side of the enclosure of the appliance, in proximity to the two opposing corners along a diagonal of the front side of the enclosure, etc.) to provide stereo imaging capability to the appliance. In some embodiments, cameras of two appliances that are placed side by side are used to provide stereo imaging capability to the appliance. In some embodiments, the stereo imaging capability is utilized to determine the distance of the user from a particular appliance and to choose which appliance is the target appliance for a detected gesture performed by the user (e.g., the closest appliance to the user is chosen as the target appliance if the user is facing the general direction of multiple appliances).

In some embodiments, the camera(s) 102 included on the appliance include image sensors for different wavelengths and/or intensities, such as infrared sensors, visible light sensors, night-vision sensors, and/or motion sensors, etc. In some embodiments, the cameras are operated on a continuous basis and produce continuous streams of image frames. In some embodiments, some cameras (e.g., infrared camera or low-light camera) are activated to capture images when one or more predefined events have been detected in the images captured by other cameras (e.g., visible light camera, etc.). For example, in some embodiments, when the ambient environment is low light (e.g., night), the night-vision camera is only activated to capture an image in response to a detection of a predefined motion event (e.g., more than a threshold amount of movement (e.g., movements less than x minutes apart) of a heat producing object (e.g., a person) for more than a predefined threshold amount of time (e.g., for more than 5 minutes) by the infrared camera.

In some embodiments, appliance 124 includes a user interface 123, the user interface includes input devices of various modalities (e.g., keyboard, touch-screen, microphone, levers, knobs, buttons, camera for capturing gestures, haptic interface, etc.) and output devices of various modalities (e.g., displays, speakers, haptic output generators, sirens, lights, indicators, etc.).

In some embodiments, the appliance operation unit 107 includes various hardware mechanisms and components for performing the native functions of the appliance (e.g., for an air conditioner, the components include a compressor, refrigerant, an evaporator, a condenser, an expansion valve, fans, air filters, one or more sensors (e.g., a thermostat, a humidity sensor, an air flow sensor, valve pressure sensors, timers, etc.)).

In some embodiments, the appliance control unit 107 includes one or more processors, and memory. The memory stores instructions which when executed by the one or more processors, cause the processors to perform functions described herein to provide controls to the native functions of the appliance, detecting presence and intent of users in the vicinity of the appliance, determining the user's gestures based on user's video images captured in the vicinity of the appliance, identifying the target appliance, generating control command for the target appliance, and coordinating the above functions among multiple appliances in the same vicinity.

In some embodiments, the appliance control unit 107 includes presence detection unit 113. The presence detection unit 113 receives input from motion detectors 101 and determines the distance of a user detected by the motion detector and whether the user movement is toward or away from the appliance based on the output of the motion detector 101. For example, if the motion detector 101 continues to detect motion, and the motion persists within the detection range of the motion detector for at least a threshold amount of time (e.g., 20 seconds), the presence detection unit 113 activates the cameras (102) to start capturing the images in the vicinity of the appliance 124. In some embodiments, the threshold distance of the user for triggering the cameras is the same as the motion detection range of the motion detectors 101. In some embodiments, two motion detectors placed at different locations on the appliance 124, or motion detectors shared by two or more appliances and are located separately on the two or more appliances are used determine the distance and the heading direction of the user detected within the detection range of the motion detectors. In some embodiments, once presence of the user is detected, and image capturing by the cameras 102 is started, the appliance control unit 107 sends the captured images, or portions of the captured images to the image processing unit 115 for gesture analysis.

In some embodiments, training of the models can be performed on the server initially, and the trained models are transmitted to the appliance 124 after some time such that the image processing unit 115 performs the image analysis locally for newly captured images. This can reduce server load, and improve privacy protection for the user.

In some embodiments, based on the result of the image analysis, the command generation unit 119 determines whether a gesture has been recognized, and determines a suitable target appliance for the gesture. The command generation unit 119 also generates the corresponding control signals for the target appliance. In some embodiments, the command generation unit 119 determines the suitable target appliance for the recognized gesture based on preset target selection criteria (e.g., based on relative positions of the appliance, the user, and other nearby appliances; and based on the type of gesture that is recognized from the users' images).

In some embodiments, the appliance control unit 107 includes a coordination unit 121. The coordination unit 121 is configured to coordinate the motion detection based on inputs from multiple motion detectors distributed among multiple appliances. For example, the motion detector output of the smart air conditioner, the motion detector output of the smart oven, and the motion detector output of the smart refrigerator, etc. are shared among the multiple appliances, such that when motion is detected by one of the multiple devices, the coordination unit 121 on each of the multiple appliances informs its local presence detection unit 113, and which can decide whether to trigger the image capturing of the local cameras, depending on whether the motion is sufficiently close to itself (e.g., the layout of the different motion detectors are shared among the multiple appliances). In some embodiments, by utilizing the multiple motion detectors on different appliances, the motion detection can be performed early enough, such that the delay in image capturing and user interface reconfiguration is reduced to improve user experience. In some embodiments, the coordination unit 121 is configured to coordinate the image capturing from multiple cameras distributed among multiple appliances. Using the images captured by multiple devices at different angles, the chance of capturing the front side of the face is improved, which is beneficial to gesture recognition. In some embodiments, the timing of the image capturing is encoded in the images, such that the movement of the user and which way the user is looking is determined based on the images captured by multiple appliances located at different positions in the room over a period of time (e.g., as the user is moving about the kitchen).

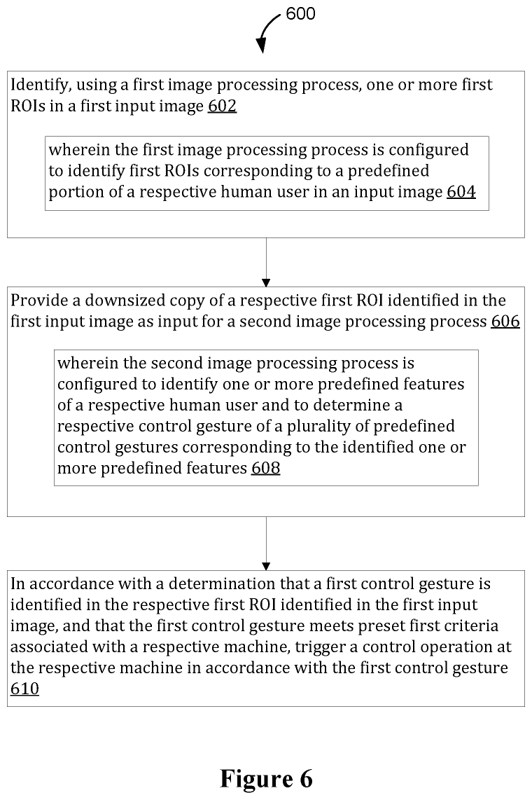

The above examples are provided merely for illustrative purposes. More details of the functions of the appliance 124 are set forth below with respect to the flowchart shown in FIG. 6.

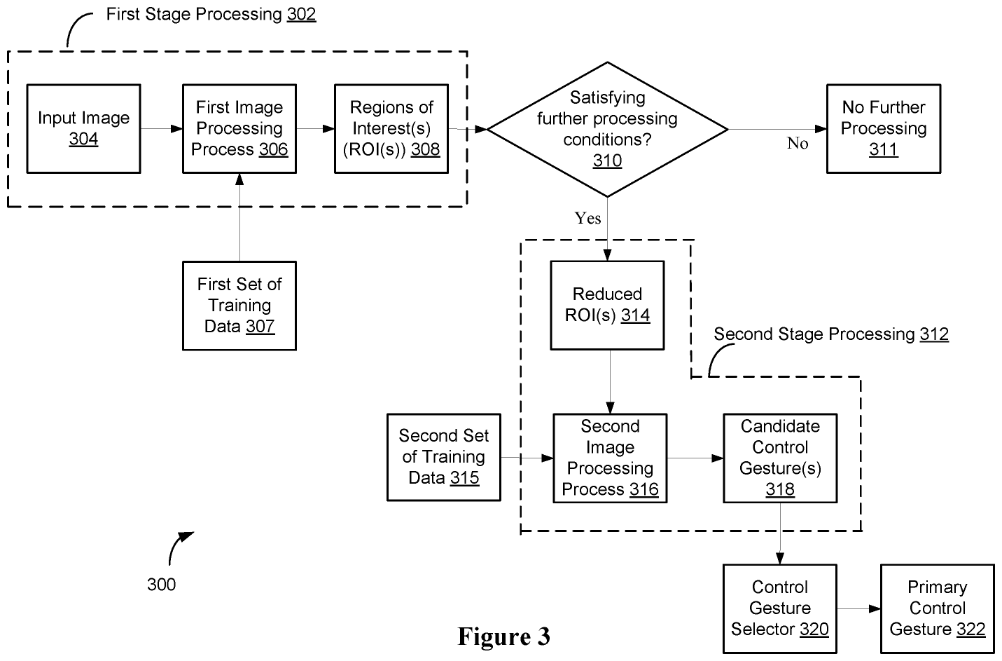

FIG. 3 illustrates a processing pipeline 300 for determining control gestures from image analysis of an image in accordance with some embodiments. The processing pipeline 300 includes a first stage processing 302, a second stage processing 312, and a control gesture selector 320. The first stage processing 302 receives an input image 304, and provides an output to the second stage processing 312, the second stage processing 312 outputs a group of candidate control gestures, and the control gesture selector 320 selects a primary control gesture 322 from the group of candidate control gestures 318. For convenience, the processing pipeline 300 is described as being performed by a computing system (e.g., the image processing unit 115 of the appliance 124 of FIG. 2, or an electronic device that located is within the smart home environment and communicates with the appliance 124).

In some embodiments, during the first stage processing 302, the computing system executes a first image processing process 306 to receive the input image 304 and output one or more regions of interests (ROIs) 308. In some embodiments, the input image 304 is captured by cameras of the appliance (e.g., the cameras 102 of the appliance 124 of FIG. 2). The one or more ROIs 308 correspond to portions of the input image 304 (e.g., portions of the input image 304 that include an upper body of a human user) and the computing system stores the one or more ROIs 308 as new images for further processing (e.g., by the second stage processing 312).

In some embodiments, the first image processing process 306 is a real-time object detection process that identifies the one or more ROIs 308 using machine learning models. For example, the first image processing process 306 can include a You-Only-Look-Once (YOLO) image detection algorithm that utilizes a single convolutional neural network for fast object detection. The first image processing process 306 receives the input image 304 and outputs a vector of bounding boxes and class prediction (e.g., corresponding to the one or more ROIs 308).

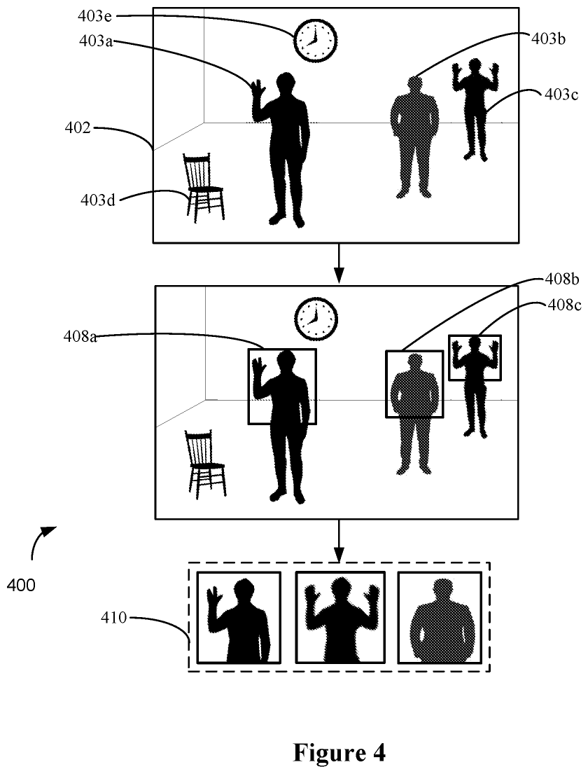

In some embodiments, the input image 304 represents a snapshot of a field of view of a camera directed to the physical environment in which the appliance is situated, and the first image processing process 306 is configured to detect in one-pass regions in the input image 304 that include an upper body of a human user. To achieve this, the first image processing process 306 has previously been trained using a first set of training data 307 that includes images labeled with predefined portions of human users (e.g., the upper body of the human user, such as head and shoulder regions of the human user). Therefore, after the computing system executes the first stage processing 302, one or more ROIs including predefined portions of human users (e.g., upper body of human user, including the head and shoulders of the human user) are generated and stored in the computing system for further processing. Refer to FIG. 4 and the related description for detail on how the computing system implements the first stage processing 302.

Next, the computing system implements an image analysis process to determine if any of the generated ROIs 308 (e.g., generated by the first stage processing 302) satisfies further processing conditions 310. If a respective ROI 308 satisfies the further processing conditions 310, the respective ROI 308 is then fed to the second stage processing 312 for further processing. Otherwise, the computing system discards the respective ROI and performs no further processing (311).

In some embodiments, determining whether the ROI 308 satisfies the further processing conditions 310 includes determining that (1) the identified upper body of the human user in the ROI 308 includes characteristics indicating that the user's face is included in the ROI 308 and the human user is facing a predefined direction (e.g., facing the appliance) when the first input 304 is captured. In some embodiments, these characteristics include presence of a set of facial landmarks. In some embodiments, these characteristics include postures classifications (e.g., turned sideways, bent over, upright, etc.) of the identified upper body in the ROI 308. In another embodiment, determining whether the ROI 308 satisfies the further processing conditions 310 includes determining that the identified upper body of the human user in the ROI 308 is within a certain region of the input image 304 (e.g., human users captured at the edge of the input image 304 would be considered too far away and not subject to further processing). In another embodiment, determining that the ROI 308 satisfies the further processing conditions 310 includes determining that the identified human user in the ROI 308 is in a predefined position such as sitting or standing (e.g., determined based on the size and height of the user in the captured image). In another embodiment, determining that the ROI 308 satisfies the further processing conditions 310 includes determining that the identified human user has kept still for a predefined time period. For example, the input image 304 is an image of a sequence of captured images (e.g., a video), and a number of previously captured images in the sequence of the captured images have the same ROIs (e.g., with the same locations and sizes) illustrating that the human user has remained in the same position. In another embodiment, determining that the ROI 308 satisfies the further processing conditions 310 includes determining that the ROI 308 satisfies a combination of any two or more the above-mentioned conditions.

If the ROI 308 satisfies the further processing conditions 310, the computing system then executes the second stage processing 312 to further process the ROI 308. At the beginning of the second stage processing 312, the ROI 308 is reduced in resolution (e.g., obtaining a smaller size) and stored in the computing system as a reduced ROI 314. A second image processing process 316 then receives the reduced ROI 314 as an input and outputs a candidate control gesture 318. In some embodiments, the candidate control gesture 318 includes a user's hand gesture such as a single-handed hand gesture (e.g., a clenched fist, an open hand, a thumb-up sign, a peace sign, an okay sign, etc.), a two-handed hand gesture (e.g., the Namaste gesture, the Merkel-Raute sign, etc.), or a combination of hand gestures and other body languages. Each candidate control gesture 318 corresponds to a unique digital control command for controlling the appliance. For example, a clenched fist near a user's head may correspond to shutting down the appliance, an open hand may correspond to turning on the appliance, a thumb-up sign may correspond to turning up the power of the appliance, etc.

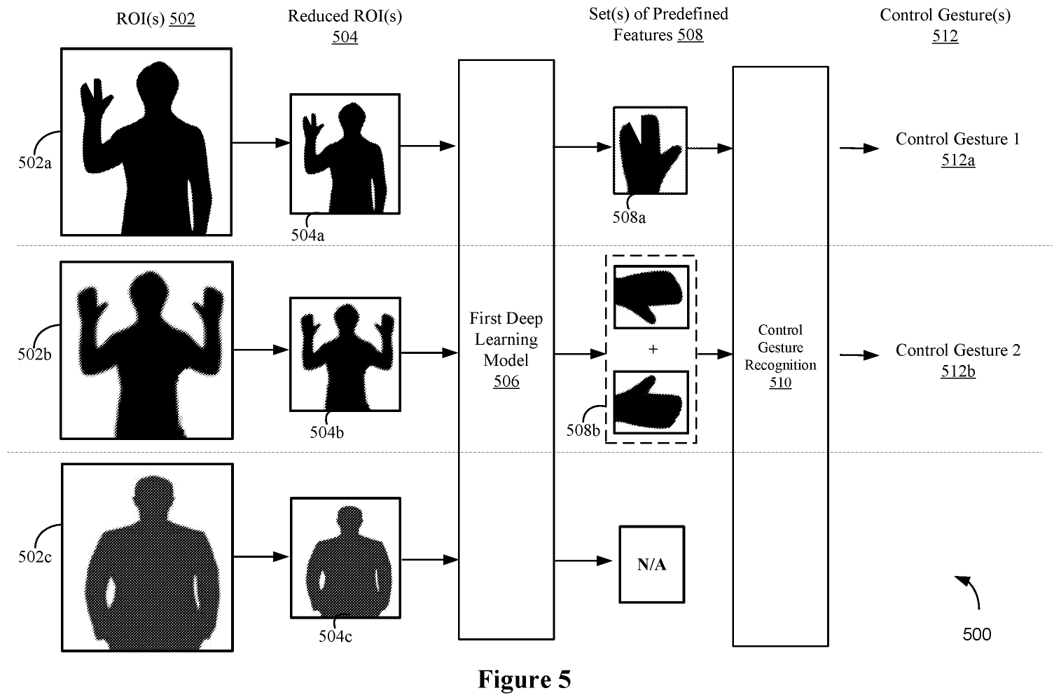

In some embodiments, the second image processing process 316 includes a real-time single-pass object detection model based on a neural network (e.g., a convolutional neural network) and a classification model (e.g., a support vector machine). The neural network receives the reduced ROIs 314 and determines a corresponding set of intermediate outputs (e.g., a set of predefined features corresponding to the user's hand gestures and head positions), and the classification model then classifies the set of intermediate outputs to a candidate control gesture 318. Each ROI 308 produces a single candidate control gesture 318. In some embodiments, the second image processing process 316 has previously been trained using a second set of training data 315 (e.g., training both the neural network and the classification model). For example, the second set of training data 315 include images corresponding to the size of the reduced ROI 314 with labeled sets of predefined features (e.g., for training the neural network), and mapping between labeled sets of predefined features to candidate control gestures 318 (e.g., for training the classification model). Refer to FIG. 5 and the related description for detail on how the computing system implements the second image processing process 316.

In some embodiments, more than one candidate control gestures 318 are generated for input image 304 (e.g., there are multiple ROIs 308 and each is associated with a different candidate control gesture 318). This may occur if, for example, there are multiple users in the input image 304 and each is presenting a control gesture. A control gesture selector 320 then receives the candidate control gestures 318 to select a control gesture as a primary control gesture 322 for the input image 304. In some embodiments, each candidate control gesture 318 is associated with a pre-assigned priority number, and determining the primary control gesture 322 includes comparing the priority number of different candidate control gestures 318. For example, if more than one candidate control gestures 318 are detected based on the reduced first ROIs 314, the control gesture selector 320 may select the candidate control gesture with the highest priority number as the primary control gesture 322. In some embodiments, instead of relying on pre-assigned priority numbers, the control gestures selector 320 determines the primary control gesture 322 based on a proximity condition such as selecting the candidate control gesture associated with a user that is closest to the camera. In some embodiments, the control gesture selector 320 also takes into account which appliance is the most likely target appliance for a control gesture when determining the primary control gesture from the multiple candidate control gestures.

FIG. 4 illustrates an image processing process 400 for determining one or more ROIs from image analysis of an input image in accordance with some embodiments. The image processing process 400 corresponds to the first image processing process 306 of FIG. 3. The image processing process 400 is a single-pass object detection process and relies on deep learning models such as a neural network to detect an ROI containing an upper body of a human user (e.g., including a user's head and shoulders).

The input image 402 serves as an input (e.g., the input image 304 of FIG. 3) to the image processing process 400. The input image 402 represents a snapshot of a field of view of a camera directed to a physical environment surrounding an appliance (e.g., the cameras onboard the appliance captures the input image 402). In this example, the input image 402 includes a plurality of items, such as three human users 403a-403c, and two objects 403d (a chair) and 403e (a clock). In some embodiments, the images are RGB images. In some embodiments, the user's hands are in front of the user's body (e.g., in front of the user's chest, or on the user's lap, etc.), rather than next to the user's torso, in the images.

The image processing process 400 relies on a deep learning model such as a trained CNN to identify regions of interest including an upper body of a human user. During training of the CNN, training images including various room scenes are labeled to indicate the locations of user's head and shoulders in the training images, and the trained deep learning model is trained to identify the presence of human user's head and shoulders and output their locations in the input images. In some embodiments, training images include images taken with different users in different postures, facing different directions, and at different distances from the camera, and images taken in different times of the day, with different lighting conditions, etc. In some embodiments, the deep learning model is also trained to output the posture of the user (e.g., facing direction of the user), such that only an ROI is only identified when the user in the image is upright and facing the camera (e.g., head and two shoulders are present in the image). In some embodiments, once the user's head location is determined and output by the deep learning model (e.g., the deep learning model is trained to only output the head location when the head is present with two shoulders in the image), the image processing process 400 generates bounding boxes (e.g., bounding boxes 408a-408c) to encompass the identified regions. In some embodiments, the size for each bounding box is determined based on the size of the upper body of the human user in the input image 400. For example, a user closer to the camera (therefore appearing larger in the input image 400) is associated with a larger bounding box (e.g., the bounding box 408a), and a user farther away from the camera (therefore appearing smaller in the input image 400) is associated with a smaller bounding box (e.g., the bounding box 408c). In some embodiments, the bounding box is a box that has a top edge centered at the top of the user's head, and has a width and height that is determined based on the size of the user's head in the image (e.g., the size of the head is generally proportional to the user's arm length and height, and is used as a base unit of length for the size of the bounding box that encloses the region that the user's hands are likely to be found).

Finally, the portions of the input image 402 within the bounding boxes are cropped and normalized to a predefined size (e.g., 400×300 pixel) and stored as output (e.g., the ROIs 308 of FIG. 3) of the image processing pipeline 400 (e.g., cropped images 410).

FIG. 5 illustrates an image processing process 500 for determining a control gesture from image analysis of an image (e.g., a first ROI) in accordance with some embodiments. The image processing process 500 corresponds to the second stage processing 312 of the processing pipeline 300 of FIG. 3. The image processing process 500 receives the ROIs from the output of the image processing process 400 (e.g., the ROIs satisfying the further processing conditions 310), and outputs a group of candidate control signals.

In some embodiments, the image processing process 500 includes a real-time one-pass object detection process. To improve computing efficiency, an input ROI 502 is preprocessed to a reduced resolution version of the stored ROI. For example, the stored ROI is an image of 400×300 pixel resolution, and the reduced resolution version is a 96×96 pixel resolution image. In some embodiments, the preprocessing includes down-sampling by predefined down-sampling ratios for the width and height of the image. For example, the input ROIs 502a-502c have each been reduced to reduced ROIs 504a-504c, respectively.

Next, a neural network model (e.g., a deep learning model) 506 receives the reduced resolution versions 504 of the ROIs as inputs to identify a set of predefined features 508. For example, the set of predefined features 508 can indicate different hand gestures (e.g., hand gestures 508a-508b) and the location of the hand gestures with respect to the user's body (e.g., with respect to the user's head). Predefined feature 508a corresponds to a single-hand gesture, predefined feature 508b corresponds to a two-hand gesture, and no predefined feature is identified for the ROI 502c. In some embodiments, the first deep learning model 506 is a neural network previously trained (e.g., using the second set of training data 315 of FIG. 3) with images labeled with the corresponding set of predefined features. For example, each training image (which is also a reduced resolution version of an ROI image of user's upper body that includes one or more hands and the user's head and two shoulders) is labeled by the user's hand gesture type, the locations of the user's head and hand(s). Once trained, the neural network model is able to output the hand gesture types and the location(s) of the hands relative to the user's head in the image.

In some embodiments, once the first deep learning model 506 extracts the set of predefined features 508, the set of predefined features 508 (e.g., the hand gesture type, the relative locations of the hand(s) and the head, etc.) is then fed to a control gesture selector (e.g., a second deep learning model or other analysis logic) 510. The control gesture selector 510 is configured to receive the set of predefined features 508 and output a control gesture. As described in FIG. 3, a control gesture represents an instruction to the appliance such as “turning on the appliance” or “adjusting the power of the appliance.” In some embodiments, the control gesture selector 510 includes a classification model such as a support vector machine (SVM). The control gesture selector 510 has previously been trained to identify control commands 512 based on sets of predefined features (508). For example, the sets of predefined features 508a and 508b cause the control gesture selector 510 to generate candidate control gestures 512a and 512b, respectively. In some embodiments, if the same starting image captured by the camera includes multiple ROIs, and from the multiple ROIs, multiple sets of predefined features are identified by the deep learning module 506, the control gesture selector 510 maps these different sets of predefined features to multiple candidate control gestures based on the hand gesture types of the hands recognized in the reduced resolution versions of the ROIs, and optionally based on the respective locations and sizes of the ROIs in the original image, the relative locations of the hand(s) if two hands are detected in the ROI, the relative locations of the hand(s) to the head in the ROI, the relative locations of the user and multiple possible target appliances, the match between the candidate control gestures and the control gestures associated with an identified target appliance, etc.

FIG. 6 is a flowchart diagram 600 of a method of controlling a machine (e.g., a home appliance) via gestures in accordance with some embodiments. For convenience, the method is described as being performed by a computing system (e.g., the appliance control unit 107 and/or the image processing unit 115 of FIG. 2).

As the first step, the computing system identifies, using a first image processing process, one or more first ROIs (e.g., regions with square, rectangular, or other shapes encompassing a predefined object) in a first input image (e.g., an image captured by an appliance when the user comes into the field of view of a camera on the appliance or an image captured by another device and sent to the appliance, or an image captured by the appliance and sent to a user device in the same smart home environment, etc.) (602). For example, the one or more first ROIs may correspond to the ROIs 502 of FIG. 5 that include an upper body of a human user (e.g., head and two shoulders of a human user). The first image processing process is configured to (e.g., includes image processing models such as neural networks that have been trained to) identify ROIs corresponding to a predefined portion of a respective human user (e.g., upper body including the head and two shoulders of the user) in an input image (604). In some embodiments, the first ROIs are identified in a real-time one-pass image detection process as described in FIG. 4 and the related description, and the first image processing process corresponds to the first image processing process 306 of FIG. 3 and the image processing process 400 of FIG. 4.

Next, the computing system provides a downsized copy (e.g., a copy reduced to a predefined pixel resolution) of a respective first ROI identified in the first input image as input for a second image processing process (606). For example, the downsized copy of the respective first ROI may correspond to the reduced ROIs 503 of FIG. 5. In some embodiments, the second image processing process is configured to (e.g., includes image processing models such as neural networks that have been trained to) identify one or more predefined features (e.g., the set of predefined features 508 of FIG. 5) of a respective human user (e.g., by a neural network trained to detect hands and heads, and recognize hand gesture types, such as the first deep learning model 506 of FIG. 5) and to determine a respective control gesture of a plurality of predefined control gestures corresponding to the identified one or more predefined features (e.g., using classification models such as a second deep learning model or other analysis logic in the control gesture selector 510). In some embodiments, the second image processing process is an end-to-end process that receives an image (e.g., the downsized copy of a first ROI) and outputs a control gesture. The second image processing process may have previously been trained using training data (e.g., the second set of training data such as images labeled with control gestures (e.g., hand gesture types, hand and head locations, etc.)). In some embodiments, the second image processing process corresponds to the second image processing process 316 of FIG. 3 and the image processing process 500 of FIG. 5, and includes one or more machine learning models (e.g., the first deep learning model 506 and a second deep learning model and other analysis models and logic in the control gesture selector 510).

In accordance with a determination that a first control gesture is identified in the respective first ROI identified in the first input image, and that the first control gesture meets preset first criteria associated with a respective machine (e.g., the respective control gesture is the primary control gesture among all the identified control gestures for a currently identified target appliance, as determined by the control gestures selector 320 of FIG. 3), the computing system triggers performance of a control operation (e.g., sending a control signal corresponding to a control command of the target appliance to the target appliance, performing the control operation at the target appliance, etc.) at the respective machine (e.g., turning on/off the target appliance, adjusting an output (sound, power, etc.) of the target appliance, setting a timer, etc.) in accordance with the first control gesture. In some embodiments, determining that the first control gesture meets the preset first criteria is performed through a control gesture selector (e.g., the control gesture selector 320 of FIG. 3), and the preset first criteria is described in FIG. 3 and the related descriptions.

In some embodiments, prior to providing the downsized copy of the respective first ROI identified in the first input image as input for the second image processing process, the computing system determines that the respective first ROI identified in the first input image satisfies further processing condition. In some embodiments, determining that the respective first ROI identified in the first input image satisfies further processing condition includes determining that the respective first ROI includes characteristics (e.g., a set of facial landmarks of the respective human user (e.g., eyes, nose, ears, eyebrows, etc.)) indicating that the respective human user is facing a predefined direction (e.g., facing the camera of the electronic device). In some embodiments, presence of two shoulders next to the head in the image or ROI is an indication that the user is facing toward the camera. In some embodiments, if the respective first ROI fails to satisfy the further processing condition, the respective first ROI is ignored (e.g., removed from memory) and is not sent to the second image processing process). In some embodiments, if the respective first ROI fails to satisfy the further processing condition, the respective first ROI is ignored and out output as an ROI by the first image processing process.

In some embodiments, the first image processing process is a single-pass detection process (e.g., the first input image is passed through the first image processing process only once and all first ROIs (if any) are identified such as You-Only-Look-Once detection or Single-Shot-Multibox-Detection algorithms). In some embodiments, identifying, using the first image processing process, the one or more first ROIs in the first input image includes: dividing the first input image into a plurality of grid cells (e.g., dividing the first image into an 10×10 grid); for a respective grid cell of the plurality of grid cells: determining, using a first neural network (e.g., the first neural network has previously been trained using labelled images with predefined objects and bounding boxes), a plurality of bounding boxes each encompassing a predicted predefined portion of the human user (e.g., a predicted upper body of the human user, e.g., with the locations of the head and shoulders labeled), wherein a center of the predicted predefined portion of the human user falls within the respective grid cell, and wherein each of the plurality of bounding boxes is associated with a class confidence score indicating a confidence level of a classification (e.g., the type of the object, e.g. a portion of the human body). In some embodiments, the first neural network has previously been trained to detect those classes of objects) of the predicted predefined portion of the human user and a confidence level of a localization of the predicted predefined portion of the human user (e.g., how accurate is the bounding box from the “ground truth box” that surrounds the object. In some embodiments, the class confidence score is a product of localization confidence and classification confidence); and identifying a bounding box with a highest class confidence score in the respective grid cell (e.g., each grid cell will only predict at most one object by removing duplicate bounding boxes through non-maximum suppression process that keeps the bounding box with the highest confidence score and removes any other boxes that overlap the bounding box with the highest confidence score by more than a certain threshold). In some embodiments, the size of the bounding box is selected based on the size of the user's head, and the location of the bounding box is selected based on the location of the user's head identified in the input image.

In some embodiments, the second image processing process is a single-pass object detection process (e.g., You-Only-Look-Once detection or Single-Shot-Multibox-Detection algorithms). In some embodiments, identifying, using the second image processing process, a respective control gesture corresponding to the respective first ROI includes: receiving the downsized copy of the respective first ROI of the plurality of first ROIs; identifying, using a second neural network, a respective set of predefined features of the respective human user; and determining, based on the identified set of predefined features of the respective human user, the respective control gesture.

In some embodiments, the one or more predefined features of the respective human user include one or both hands and a head of the respective human user. In some embodiments, the predefined features include the locations and hand gesture type for each hand identified in the downsized copy of the first ROI. The relative locations of the hand(s) in conjunction with the location of the head (e.g., known from the output of the first image processing process) determines the relative locations of the hand(s) and the head in the first ROI.

In some embodiments, identifying the first control gesture includes identifying two separate hand gestures corresponding to two hands of the respective human user and mapping a combination of the two separate hand gestures to the first control gesture. For example, two open hands are detected in the downsized first ROI, if the two open hands are detected next to the head, a control gesture for turning on a device is identified; and if the two open hands are detected below the head, a control gesture for turning off the device is identified. If only a single open hand is detected in the downsized first ROI next to the head, a control gesture for pausing the device is identified.

In some embodiments, determining the respective control gesture of a plurality of predefined control gestures corresponding to the identified one or more predefined features includes determining a location of the predefined features of the respective human user with respect to an upper body (e.g., the head, or other hand) of the respective human user.

In some embodiments, the preset first criteria associated with the respective machine include a criterion that is met in accordance with a determination that the same control gesture is recognized in a sequence of images (e.g., 5 images captured 200 milliseconds apart) captured by the camera during a preset time period (e.g., 5 seconds). In some embodiments, the preset first criteria associated with the respective machine includes a criterion that is met in accordance with a determination that the control gesture output by the second image processing process matches one of the set of control gestures associated with a currently identified target appliance (e.g., the appliance that captured the image, the appliance that is closest to the user, the appliance activated by the user using another input method (e.g., a wake up word), etc.).

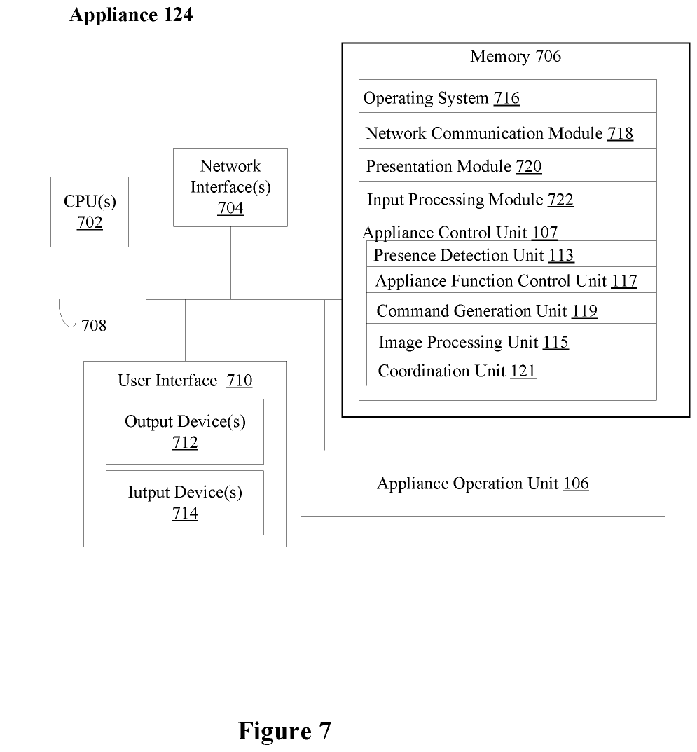

FIG. 7 is a block diagram illustrating a representative appliance 124. The appliance 124 includes one or more processing units (CPUs) 702, one or more network interfaces 704, memory 706, and one or more communication buses 708 for interconnecting these components (sometimes called a chipset). Appliance 124 also includes a user interface 710. User interface 710 includes one or more output devices 712 that enable the presentation of media content, including one or more speakers and/or one or more visual displays. User interface 710 also includes one or more input devices 714, including user interface components that facilitate user input such as a keyboard, a mouse, a voice-command input unit or microphone, a touch screen display, a touch-sensitive input pad, a gesture capturing camera, or other input buttons or controls. In some embodiments, appliance 124 further includes sensors, which senses operating environment information of the appliance 124. Sensors include but are not limited to one or more microphones, one or more cameras, an ambient light sensor, one or more accelerometers, one or more gyroscopes, a GPS positioning system, a Bluetooth or BLE system, a temperature sensor, humidity sensors, one or more motion sensors, one or more biological sensors (e.g., a galvanic skin resistance sensor, a pulse oximeter, and the like), and other sensors. Furthermore, the appliance 124 includes appliance operation unit 106. Memory 706 includes high-speed random access memory, such as DRAM, SRAM, DDR RAM, or other random access solid-state memory devices; and, optionally, includes non-volatile memory, such as one or more magnetic disk storage devices, one or more optical disk storage devices, one or more flash memory devices, or one or more other non-volatile solid state storage devices. Memory 706, optionally, includes one or more storage devices remotely located from one or more processing units 702. Memory 706, or alternatively the non-volatile memory within memory 706, includes a non-transitory computer-readable storage medium. In some implementations, memory 706, or the non-transitory computer-readable storage medium of memory 706, stores the following programs, modules, and data structures, or a subset or superset thereof:
operating system 716 including procedures for handling various basic system services and for performing hardware dependent tasks;
network communication module 718 for connecting appliance 124 to other computing devices (e.g., a server system 108) or mobile control devices (e.g., smartphones or tablets) connected to one or more networks via one or more network interfaces 704 (wired or wireless);
presentation module 720 for enabling the presentation of information;
input processing module 722 for detecting one or more user inputs or interactions from one of the one or more input devices 714 and interpreting the detected input or interaction;
appliance control unit 107, which controls the appliance 124, including but not limited to presence detection unit 113, appliance function control unit 117, image processing unit 115, command generation unit 119, and coordination unit 121, and other modules for performing other functions set forth herein.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 706, optionally, stores a subset of the modules and data structures identified above. Furthermore, memory 706, optionally, stores additional modules and data structures not described above.

While particular embodiments are described above, it will be understood it is not intended to limit the application to these particular embodiments. On the contrary, the application includes alternatives, modifications, and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

What is claimed is:

1. A method comprising:
at an electronic device having one or more processors, a camera, and memory:
identifying, using a first image processing process, one or more first regions of interest (ROI) in a first input image, wherein the first image processing process is configured to identify first ROIs corresponding to a predefined portion of a respective human user in an input image;
providing a downsized copy of a respective first ROI identified in the first input image as input for a second image processing process, wherein the second image processing process is configured to identify one or more predefined features of a respective human user and to determine a respective control gesture of a plurality of predefined control gestures corresponding to the identified one or more predefined features; and
in accordance with a determination that a first control gesture is identified in the respective first ROI identified in the first input image, and that the first control gesture meets preset first criteria associated with a respective machine, triggering a control operation at the respective machine in accordance with the first control gesture.

2. The method of claim 1, including:
prior to providing the downsized copy of the respective first ROI identified in the first input image as input for the second image processing process, determining that the respective first ROI identified in the first input image includes characteristics indicating that the respective human user is facing a predefined direction.

3. The method of claim 1, wherein identifying, using the first image processing process, the one or more first ROIs in the first input image includes:
dividing the first input image into a plurality of grid cells;
for a respective grid cell of the plurality of grid cells:
determining, using a first neural network, a plurality of bounding boxes each encompassing a predicted predefined portion of the human user, wherein a center of the predicted predefined portion of the human user falls within the respective grid cell, and wherein each of the plurality of bounding boxes is associated with a class confidence score indicating a confidence level of a classification of the predicted predefined portion of the human user and a confidence level of a localization of the predicted predefined portion of the human user; and
identifying a bounding box with a highest class confidence score in the respective grid cell.

4. The method of claim 1, wherein identifying, using the second image processing process, a respective control gesture corresponding to the respective first ROI includes:
receiving the downsized copy of the respective first ROI of the plurality of first ROIs;
identifying, using a second neural network, a respective set of predefined features of the respective human user; and
determining, based on the identified set of predefined features of the respective human user, the respective control gesture.

5. The method of claim 1, wherein the one or more predefined features of the respective human user correspond to one or both hands and a head of the respective human user.

6. The method of claim 1, wherein identifying the first control gesture includes identifying two separate hand gestures corresponding to two hands of the respective human user and mapping a combination of the two separate hand gestures to the first control gesture.

7. The method of claim 1, wherein determining the respective control gesture of the plurality of predefined control gestures corresponding to the identified one or more predefined features includes determining a respective location of at least one of the identified one or more predefined features of the respective human user with respect to an upper body of the respective human user.

8. A non-transitory computer-readable storage medium, including instructions, the instructions, when executed by one or more processors of a computing system, cause the processors to perform operations comprising:
identifying, using a first image processing process, one or more first regions of interest (ROI) in a first input image, wherein the first image processing process is configured to identify first ROIs corresponding to a predefined portion of a respective human user in an input image;
providing a downsized copy of a respective first ROI identified in the first input image as input for a second image processing process, wherein the second image processing process is configured to identify one or more predefined features of a respective human user and to determine a respective control gesture of a plurality of predefined control gestures corresponding to the identified one or more predefined features; and
in accordance with a determination that a first control gesture is identified in the respective first ROI identified in the first input image, and that the first control gesture meets preset first criteria associated with a respective machine, triggering a control operation at the respective machine in accordance with the first control gesture.

9. The non-transitory computer-readable storage medium of claim 8, wherein the operations include:
prior to providing the downsized copy of the respective first ROI identified in the first input image as input for the second image processing process, determining that the respective first ROI identified in the first input image includes characteristics indicating that the respective human user is facing a predefined direction.

10. The non-transitory computer-readable storage medium of claim 8, wherein identifying, using the first image processing process, the one or more first ROIs in the first input image includes:
dividing the first input image into a plurality of grid cells;
for a respective grid cell of the plurality of grid cells:
determining, using a first neural network, a plurality of bounding boxes each encompassing a predicted predefined portion of the human user, wherein a center of the predicted predefined portion of the human user falls within the respective grid cell, and wherein each of the plurality of bounding boxes is associated with a class confidence score indicating a confidence level of a classification of the predicted predefined portion of the human user and a confidence level of a localization of the predicted predefined portion of the human user; and
identifying a bounding box with a highest class confidence score in the respective grid cell.

11. The non-transitory computer-readable storage medium of claim 8, wherein identifying, using the second image processing process, a respective control gesture corresponding to the respective first ROI includes:
receiving the downsized copy of the respective first ROI of the plurality of first ROIs;
identifying, using a second neural network, a respective set of predefined features of the respective human user; and
determining, based on the identified set of predefined features of the respective human user, the respective control gesture.

12. The non-transitory computer-readable storage medium of claim 8, wherein the one or more predefined features of the respective human user correspond to one or both hands and a head of the respective human user.

13. The non-transitory computer-readable storage medium of claim 8, wherein identifying the first control gesture includes identifying two separate hand gestures corresponding to two hands of the respective human user and mapping a combination of the two separate hand gestures to the first control gesture.

14. The non-transitory computer-readable storage medium of claim 8, wherein determining the respective control gesture of the plurality of predefined control gestures corresponding to the identified one or more predefined features includes determining a respective location of at least one of the identified one or more predefined features of the respective human user with respect to an upper body of the respective human user.

15. A computing system, comprising:
one or more processors; and
memory storing instructions, the instructions, when executed by the one or more processors, cause the processors to perform operations comprising:
identifying, using a first image processing process, one or more first regions of interest (ROI) in a first input image, wherein the first image processing process is configured to identify first ROIs corresponding to a predefined portion of a respective human user in an input image;
providing a downsized copy of a respective first ROI identified in the first input image as input for a second image processing process, wherein the second image processing process is configured to identify one or more predefined features of a respective human user and to determine a respective control gesture of a plurality of predefined control gestures corresponding to the identified one or more predefined features; and
in accordance with a determination that a first control gesture is identified in the respective first ROI identified in the first input image, and that the first control gesture meets preset first criteria associated with a respective machine, triggering a control operation at the respective machine in accordance with the first control gesture.

16. The computing system of claim 15, wherein the operations include:
prior to providing the downsized copy of the respective first ROI identified in the first input image as input for the second image processing process, determining that the respective first ROI identified in the first input image includes characteristics indicating that the respective human user is facing a predefined direction.

17. The computing system of claim 15, wherein wherein identifying, using the first image processing process, the one or more first ROIs in the first input image includes:
dividing the first input image into a plurality of grid cells;
for a respective grid cell of the plurality of grid cells:
determining, using a first neural network, a plurality of bounding boxes each encompassing a predicted predefined portion of the human user, wherein a center of the predicted predefined portion of the human user falls within the respective grid cell, and wherein each of the plurality of bounding boxes is associated with a class confidence score indicating a confidence level of a classification of the predicted predefined portion of the human user and a confidence level of a localization of the predicted predefined portion of the human user; and
identifying a bounding box with a highest class confidence score in the respective grid cell.

18. The computing system of claim 15, wherein identifying, using the second image processing process, a respective control gesture corresponding to the respective first ROI includes:
receiving the downsized copy of the respective first ROI of the plurality of first ROIs;
identifying, using a second neural network, a respective set of predefined features of the respective human user; and
determining, based on the identified set of predefined features of the respective human user, the respective control gesture.

19. The computing system of claim 15, wherein the one or more predefined features of the respective human user correspond to one or both hands and a head of the respective human user.

20. The computing system of claim 15, wherein identifying the first control gesture includes identifying two separate hand gestures corresponding to two hands of the respective human user and mapping a combination of the two separate hand gestures to the first control gesture.
